(19) United States
(12) Patent Application Publication
(10) Pub. No.: US 2024/0230819 A1
(43) Pub. Date: Jul. 11, 2024

(54) METHOD OF DIRECTION ESTIMATION FOR NONCIRCULAR SIGNALS VIA DECOUPLED OPTIMIZATION

(71) Applicant: KANGWON NATIONAL UNIVERSITY-INDUSTRY COOPERATION FOUNDATION, Chuncheon-si (KR)

(72) Inventor: YANG HO CHOI, Chuncheon-si (KR)

(21) Appl. No.: 18/088,709

(22) Filed: Dec. 26, 2022

(51) Int. Cl. G01S 3/802

(52) U.S. Cl. CPC G01S 3/8022

(57) ABSTRACT

The disclosure presents a method that estimates the arrival angles of noncircular signals incident on a sensor array based on the ML principle. The complex multidimensional problem according to the ML is transformed into a series of simple problems through the separation of one from the superimposed signals, which leads to the optimization of the function of the two-variable θ and ϕ associated with, respectively, the direction and the initial phase of the separated signal. The optimum value of ϕ is theoretically solved. Then the arrival angle of the separated signal is efficiently estimated through a simple 1-D search with respect to θ. Such an optimization process, updating signal separations, is iterated until the direction estimates converge. The proposed method can be applied also in the presence of Doppler effect.

### BACKGROUND

### Description of Related Art

The arrival angles of the signals incident onto a sensor array can be estimated by relying on the maximum likelihood (ML) principle, which can provide better performance than on the multiple signal classification (MUSIC) principle that the signal subspace is orthogonal to the noise subspace. However, the former requires solving a nonlinear multidimensional problem. Suboptimal solutions can be obtained by transforming the multidimensional problem into iterative one-dimensional (1-D) problems through signal separations. The separation of one signal from the superimposed signals is made by removing the contributions of the others (A. J. Weiss et al, J. Yin et al). Then, the parameters associated with the separated signal are optimized. Such an optimization is repeated from signal to signal. The basic idea of separation has also been applied to the estimation of time delays based on the least square in the frequency domain (R. Wu et al, J. Li et al).

If the incident signals are noncircular so that the averages of their squared complex envelopes, as in binary phase shift keying (BPSK) and amplitude shift keying (ASK), are nonzero, the noncircularity can be exploited to improve estimation performance (Y.-H. Choi; P. Charge et al.). Various methods for direction finding have been suggested that use noncircularity, but without the consideration of the Doppler effect. If there is relative motion between receivers and transmitters Doppler shifts take place, which can cause severe performance degradation with no consideration of the effect. Recently, based on signal separation, a direction estimation method has been presented that deals with the Doppler effect when noncircular signals impinge on a moving array (B. Yang et al.). It eigen-decomposes a matrix of size N at each search point to find the optimal one, where Nis the number of snapshots used for the estimation. The eigen-decomposition would be computationally very intensive, particularly when N is large. This existing method is termed decoupled estimation method 2 (DEM2).

### SUMMARY

This disclosure presents a method that estimates the arrival angles of noncircular signals incident on a sensor array based on the maximum likelihood (ML) principle. The ML estimation of the directions of noncircular signals is formulated as a complex multidimensional problem, which is transformed into a series of simple problems through signal separations. The separation of one from the superimposed signals impinging on the sensor array is made by removing the contributions of the others, which are deduced from the parameters estimated through the previous steps. The formulation for the separated signal results in the optimization of a function of two variables θ and ϕ associated with its direction and initial phase, respectively. Given θ, the optimum of ϕ is theoretically solved, which enables us to efficiently estimate the arrival angles. Then the optimization with respect to θ is carried out through a simple one-dimensional (1-D) search. Such an optimization process, updating signal separations, is iterated until the direction estimates converge. In other words, the iteration is terminated when the differences between the present and the previous estimates are very small. The proposed method, which is referred to as DEM1, can also be applied in the presence of Doppler effect.

### BRIEF DESCRIPTION OF THE DRAWINGS

The above and other aspects, and advantages of certain embodiments of the disclosure will be more apparent from the following description taken in conjunction with the accompanying drawings, in which:

FIG. 1 shows the computational procedure of the proposed method, DEM1.

FIG. 2 is a graph comparing the computational complexities of DEM1 and DEM2 with respect to the number of snapshots.

FIG. 3 is a graph comparing the cost functions gₖ⁽ⁱ⁾(θ) and hₖ⁽ⁱ⁾(θ), k=1, 2, of DEM1 and DEM2, respectively, at the 2nd iteration.

FIG. 4 compares the root mean square error (RMSE) of DEM1 with those of other methods as functions of signal-to-noise ratio (SNR).

FIG. 5 compares the RMSE of DEM1 with those of other methods as functions of the Doppler constant.

FIG. 6 is a block diagram of direction estimator according to an embodiment of the disclosure.

### DETAILED DESCRIPTION

Before specifically describing the disclosure, a method for demonstrating the present specification and drawings will be described.

First of all, the terms used in the present specification and the claims are general terms identified in consideration of the functions of the various embodiments of the disclosure. However, these terms may vary depending on intention, legal or technical interpretation, emergence of new technologies, and the like of those skilled in the related art. Also, there may be some terms arbitrarily identified by an applicant. Unless there is a specific definition of a term, the term may be construed based on the overall contents and technological common sense of those skilled in the related art.

Further, like reference numerals indicate like components that perform substantially the same functions throughout the specification. For convenience of descriptions and understanding, the same reference numerals or symbols are used and described in different exemplary embodiments. In other words, although elements having the same reference numerals are all illustrated in a plurality of drawings, the plurality of drawings do not mean one exemplary embodiment.

In the disclosure, relational terms such as first and second, and the like, may be used to distinguish one entity from another entity, without necessarily implying any actual relationship or order between such entities. In embodiments of the disclosure, relational terms such as first and second, and the like, may be used to distinguish one entity from another entity, without necessarily implying any actual relationship or order between such entities.

The terms used herein are solely intended to explain a specific exemplary embodiment, and not to limit the scope of the disclosure. It is to be understood that the singular forms include plural referents unless the context clearly dictates otherwise. The terms “include”, “comprise”, “is configured to,” etc., of the description are used to indicate that there are features, numbers, steps, operations, elements, parts or combination thereof, and they should not exclude the possibilities of combination or addition of one or more features, numbers, steps, operations, elements, parts or a combination thereof.

The term such as “module,” “unit,” “part”, and so on is used to refer to an element that performs at least one function or operation, and such element may be implemented as hardware or software, or a combination of hardware and software. Further, except for when each of a plurality of “modules”, “units”, “parts”, and the like needs to be realized in an individual hardware, the components may be integrated in at least one module or chip and be realized in at least one processor.

Also, when any part is connected to another part, this includes a direct connection and an indirect connection through another medium. Further, when a certain portion includes a certain element, unless specified to the contrary, this means that another element may be additionally included, rather than precluding another element.

Hereinafter, the disclosure is described in detail. A linear array may consists of M sensors, and K narrowband signals impinge on the array from θ={θᵢ, . . . , θ_{K}} where θₖ is the arrival angle of the kth signal. The array response vector is denoted by a(θ) for a direction θ. The received signal vector can be expressed as

$$x ( t ) = A ( θ ) s ( t ) + n ( t ) \qquad ( 1 )$$

where A(θ)=[a(θ₁), . . . , a(θ_{K})], s(t) is a complex envelope vector of the received signals, and n(t) is the noise vector. Noise is assumed to be a circularly symmetric complex Gaussian random process with zero mean and variance σ² and to be uncorrelated from element to element so that

$$E [ n ( t ) {n}^{H} ( t ) ] = {σ}^{2} I \qquad ( 2 )$$

where E, H, and I designate expectation, complex conjugate transpose, and an identity matrix respectively.

The incoming signals are fully noncircular and their initial phases are ϕ={ϕ₁, . . . , ϕ_{K}} where ϕₖ is the initial phase of the kth signal. Then the complex envelope vector s(t) can be written as

$$s ( t ) = B ( ϕ ) γ ( t ) \qquad ( 3 )$$

where

$$B ( ϕ ) = diag [ {e}^{j {ϕ}_{1}} , … , {e}^{j {ϕ}_{K}} ] \qquad ( 4 )$$

$$γ ( t ) = {[ {γ}_{1} ( t ) , … , {γ}_{K} ( t ) ]}^{T}$$

with T standing for the transpose. If sₖ(t) is a BPSK signal γₖ(+) has a value of +A or −A where A is an amplitude. In (3), γ(t) is a real vector. Substituting (3) into (1) yields

$$x ( t ) = A ( θ ) B ( ϕ ) γ ( t ) + n ( t ) \qquad ( 6 )$$

For the sake of simplicity, the Doppler effect is not considered in this step and is described later.

N snapshots x(1), . . . , x(N) are available. The arrival angles can be estimated based on the deterministic ML criterion, in which the cost function can be written as

$${f}_{ML} = {\sum }_{n = 1}^{N} {‖ x ( n ) - A ( θ ) B ( ϕ ) γ ( n ) ‖}^{2} \qquad ( 7 )$$

where ∥⋅∥ denotes the Euclidean norm. The minimization of ƒ_{ML} is a nonlinear multidimensional problem. Applying signal separation, we can transform it into iterative 1-D problems. The parameters related to the kth signal are θₖ, ϕₖ, and γₙ(n), n=1, . . . , N. At the kth step in the ith iteration, the estimates θₖ⁽ⁱ⁾, ϕₖ⁽ⁱ⁾, and γₖ⁽ⁱ⁾(n) for them are attained. To this end, the other signal components, which are deduced from the parameters estimated through the previous steps, are removed from the snapshot data. The resulting decoupled vector can be expressed as

$${z}_{k}^{( i )} ( n ) = x ( n ) - A ( {θ}_{k}^{( i )} ) B ( {ϕ}_{k}^{( i )} ) {γ}_{k}^{( i )} ( n ) \qquad ( 8 )$$

where

$${γ}_{k}^{( i )} ( n ) = {[ {y}_{1}^{( i )} ( n ) , … , {y}_{k - 1}^{( i )} ( n ) , {y}_{k + 1}^{( i )} ( n ) , … , {y}_{K}^{( i )} ( n ) ]}^{T} \qquad ( 9 )$$

$${θ}_{k}^{( i )} = \{ {θ}_{1}^{( i )} , … , {θ}_{k - 1}^{( i )} , {θ}_{k + 1}^{( i - 1 )} , … , {θ}_{K}^{( i - 1 )} \{ \} \qquad ( 10 )$$

and ϕₖ⁽ⁱ⁾ is similarly defined. Then the following cost function is minimized to find the estimates:

$${f}_{k}^{( i )} = {\sum }_{n = 1}^{N} {‖ {z}_{k}^{( i )} ( n ) - {e}^{j ϕ} a ( θ ) γ ( n ) ‖}^{2} \qquad ( 11 )$$

Minimizing ƒₖ⁽ⁱ⁾ with respect to a real number γ(n) leads to

$$γ ( n ) = \frac{Re ( {e}^{- j ϕ} {a}^{H} ( θ ) {z}_{k}^{( i )} ( n ) )}{{‖ a ( θ ) ‖}^{2}} \qquad ( 12 )$$

Re(⋅) and Im(⋅) represent the real and imaginary parts of a complex number, respectively. When replacing γ(n) in (11) by (12), the minimization of ƒₖ⁽ⁱ⁾ becomes equivalent to the maximization of

$${g}_{k}^{( i )} ( θ , ϕ ) = {\sum }_{n = 1}^{N} \frac{{[ Re ( {e}^{- j ϕ} {a}^{H} ( θ ) {z}_{k}^{( i )} ( n ) ) ]}^{2}}{{‖ a ( θ ) ‖}^{2}} \qquad ( 13 )$$

It is straightforward to see that gₖ⁽ⁱ⁾(θ,ϕ) is written as

$${g}_{k}^{( i )} ( θ , ϕ ) = \frac{{d}_{1} {e}^{j 2 ϕ} + {d}_{1}^{*} {e}^{- j 2 ϕ} + 2 {d}_{0}}{4 {‖ a ( θ ) ‖}^{2}} \qquad ( 14 )$$

where

$${d}_{0} = {\sum }_{n = 1}^{N} {\vert {a}^{T} ( θ ) {z}_{k}^{( i ) *} ( n ) \vert}^{2} \qquad ( 15 a )$$

$${d}_{1} = {\sum }_{n = 1}^{N} {a}^{T} ( θ ) {{z}_{k}^{( i ) *} ( n )}^{2} \qquad ( 15 b )$$

with * denoting the complex conjugate. For notational convenience, the dependency of d₀ and d₁ on θ were omitted. Note that the real number d₀ is independent of ϕ. Let d₁=|d₁|e^{jψ}. Given θ, clearly the maximum of gₖ⁽ⁱ⁾(θ,ϕ) with respect to ϕ becomes

$${g}_{k}^{( i )} ( θ ) = \frac{\vert {d}_{1} \vert + {d}_{0}}{2 {‖ a ( θ ) ‖}^{2}} \qquad ( 16 )$$

when

$$ϕ = - \frac{ψ}{2} \qquad ( 17 )$$

The estimate θₖ⁽ⁱ⁾ is obtained as

$${θ}_{k}^{( i )} = arg {max}_{θ} {g}_{k}^{( i )} ( θ ) \qquad ( 18 )$$

Once θₖ⁽ⁱ⁾ is discovered, the estimate ϕₖ⁽ⁱ⁾ is given by (17) with θ=θₖ⁽ⁱ⁾ and then γₖ⁽ⁱ⁾(n) by (12). If, θₖ⁽ⁱ⁾, ϕₖ⁽ⁱ⁾(n) and γₖ⁽ⁱ⁾(n) are obtained, zₖ₊₁⁽ⁱ⁾(n) can be calculated as

$${z}_{k + 1}^{( i )} ( n ) = {z}_{k}^{( i )} ( n ) + {y}_{k}^{( i )} ( n ) - {y}_{k + 1}^{( i - 1 )} ( n ) , n = 1 , … , N \qquad ( 19 )$$

where

$${y}_{p}^{( q )} ( n ) = {e}^{j {ϕ}_{p}^{( q )}} a ( {θ}_{p}^{( q )} ) {γ}_{p}^{( q )} ( n ) \qquad ( 20 )$$

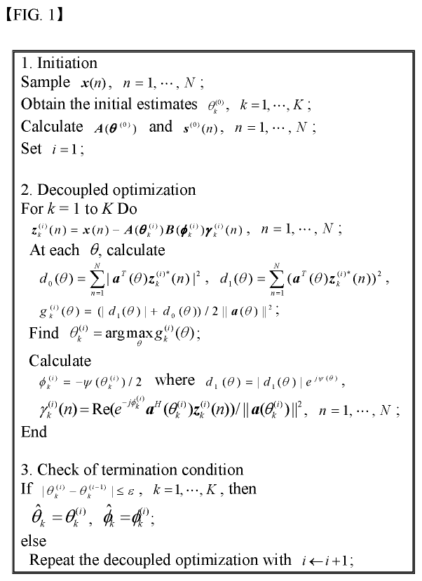

The next step proceeds to find θₖ₊₁⁽ⁱ⁾. The iteration is terminated if

$$\vert {θ}_{k}^{( i )} - {θ}_{k}^{( i - 1 )} \vert \leq ε , k = 1 , … , K \qquad ( 21 )$$

where ε is a small constant. The computational procedure of the proposed method, DEM1, is shown in FIG. 1 where θ⁽⁰⁾={θ₁⁽⁰⁾, . . . , θ_{K}⁽⁰⁾}, s₀⁽⁰⁾(n)=[s₀⁽⁰⁾(n), . . . , s_{K}⁽⁰⁾(n)]^{T}, and d₀ and d₁ are explicitly expressed as functions of θ. With θ⁽⁰⁾ obtained, s₀⁽⁰⁾(n) can be computed as s₀⁽⁰⁾(n)=A(θ⁽⁰⁾)(A^{H}(θ⁽⁰⁾)A(θ⁽⁰⁾))⁻¹A^{H}(θ⁽⁰⁾)x(n). When i=1, zₖ⁽ⁱ⁾(n) is calculated as zₖ⁽¹⁾(n)=x(n)−A(θₖ⁽¹⁾)sₖ⁽¹⁾(n) where sₖ⁽¹⁾(n)=[s₁⁽¹⁾(n), . . . , sₖ₋₁⁽¹⁾(n), sₖ₊₁⁽⁰⁾(n), . . . , s_{K}⁽⁰⁾(n)]^{T}.

In the following, for comparison, we briefly introduce the conventional method, DEM2, by B. Yang et al. The direction estimates in DEM2 are also obtained via the minimization of ƒₖ⁽ⁱ⁾, which can be represented as

$${f}_{k}^{( i )} = {‖ {z}_{k}^{( i )} - μ C ( θ ) u ‖}^{2} \qquad ( 22 )$$

where zₖ⁽ⁱ⁾=[zₖ^{(i)T}(1), . . . , zₖ^{(i)T}(N)]^{T}, C(θ) is the N×N block diagonal matrix given as C(θ)=blkdiag[a(θ), . . . , a(θ)], μ is a complex number, and u is a real vector with unit norm. Comparing (11) and (22), we see

$$μ u = {e}^{j ϕ} γ \qquad ( 23 )$$

where γ=[γ(1), . . . , γ(N)]^{T} is a real vector. It is obvious that for arbitrary μ, ϕ, u, and γ, the set of the complex vectors that has the form of μu is the same as that of e^{jϕ}γ. The complex number μ that minimizes (22) for a given θ is

$$μ = \frac{{u}^{H} h ( θ )}{{‖ C ( θ ) u ‖}^{2}} \qquad ( 24 )$$

where

$$h ( θ ) = {C}^{H} ( θ ) {z}_{k}^{( i )} \qquad ( 25 )$$

The minimization of (22) after the substitution of (24) is reduced to the maximization of

$${h}_{k}^{( i )} ( θ , u ) = {\vert {u}^{H} h ( θ ) \vert}^{2} \qquad ( 26 )$$

subject to ∥u∥=1, where ∥a(θ)∥ is assumed to be a constant. The complex vector h(θ) is written as

$$h ( θ ) = {h}_{r} ( θ ) + j {h}_{i} ( θ ) \qquad ( 27 )$$

where hᵣ(θ) and hᵢ(θ) are real vectors. The maximum of hₖ⁽ⁱ⁾(θ, u) with respect to u is equal to the maximal eigenvalue of H′(θ) given as

$${H}^{′} ( θ ) = H ( θ ) {H}^{T} ( θ ) \qquad ( 28 )$$

where

$$H ( θ ) = [ {h}_{r} ( θ ) , {h}_{i} ( θ ) ] \qquad ( 29 )$$

The estimate of θₖ⁽ⁱ⁾ is given by

$${θ}_{k}^{( i )} = arg {max}_{θ} {h}_{k}^{( i )} ( θ ) \qquad ( 30 )$$

where

$${h}_{k}^{( i )} ( θ ) = {λ}_{max} ( {H}^{′} ( θ ) ) \qquad ( 31 )$$

The maximization of (30) is solved through the eigen-decomposition of N×N matrices H′(θ) at every search point θ. Once θₖ⁽ⁱ⁾ is obtained, μₖ⁽ⁱ⁾ is given by (24) with θ=θₖ⁽ⁱ⁾ and zₖ₊₁⁽ⁱ⁾ can be calculated as

$${z}_{k + 1}^{( i )} = {z}_{k}^{( i )} + {y}_{k}^{( i )} - {y}_{k + 1}^{( i - 1 )} \qquad ( 32 )$$

where yₚ^{(q)}=μₚ^{(q)}C(θₚ⁽¹⁾)uₚ^{(q)}

The estimates of both (18) and (30) are found by minimizing the cost function (11). As mentioned above, the sets of complex vectors μu and of complex vectors e^{jϕ}γ are the same. Hence, (18) and (30) are identical. When γ(n) is given by (12), gₖ⁽ⁱ⁾(θ,ϕ) is related to ƒₖ⁽ⁱ⁾ by

$${g}_{k}^{( i )} ( θ , ϕ ) = {‖ {z}_{k}^{( i )} ‖}^{2} - {f}_{k}^{( i )} \qquad ( 33 )$$

In addition, hₖ⁽ⁱ⁾(θ, u), when μ is given by (24), is expressed as

$${h}_{k}^{( i )} ( θ , u ) = ( {‖ {z}_{k}^{( i )} ‖}^{2} - {f}_{k}^{( i )} ) {‖ a ( θ ) ‖}^{2} \qquad ( 34 )$$

As a result, under the assumption of the constant

$${h}_{k}^{( i )} ( θ ) = {‖ a ( θ ) ‖}^{2} {g}_{k}^{( i )} ( θ ) \qquad ( 35 )$$

It is seen from (35) that when ∥a(θ)∥ is independent of θ the estimates are the same.

TABLE I

| DEM1 | DEM2 |
|---|---|
| [symbol] : O(4NM + 4N) | [symbol] : O(8NM + 2N) |
| d [symbol] d [symbol] : O(4NM + 3N) | [symbol] : O(4NM + N [symbol] + N) |
| g [symbol] (θ): O(0) | h [symbol] (θ): O(N [symbol] ) |

Overall load for the computation of θ

[symbol]

| | |
|---|---|
| O(N [symbol] (4NM + | O(N [symbol] (4NM + N [symbol] + |
| 3N) + 4NM + 4N) | N [symbol] + N [symbol] + 8NM + 2N) |

[symbol]

indicates data missing or illegible when filed

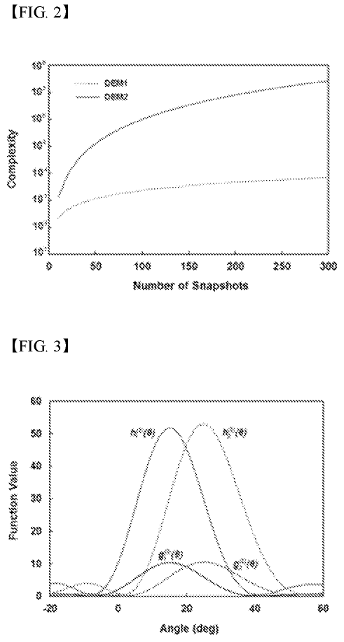

The computational loads for θₖ⁽ⁱ⁾ of DEM1 and DEM2 are compared in terms of the number of real multiplications in Table I. Ng designates the number of search points and O(0) indicates that the complexity is neither dependent on N nor M. The decoupled vector zₖ⁽ⁱ⁾, which does not depend on θ, is calculated, with the replacement of k by k−1, as (19) in DEM1 and as (32) in DEM2. The computation of C^{H}(θ)zₖ⁽ⁱ⁾ requires multiplication of O(4NM). At each grid point θ, the quantities d₀, d₁, and gₖ⁽ⁱ⁾(θ) in DEM1 or H′(θ) and hₖ⁽ⁱ⁾(θ) in DEM2 are evaluated, the complexities of which are O(4NM) and O(N³+N²+4NM), respectively. In FIG. 2 the complexities at each search point are compared when M=5. The computational load of DEM2 is huge for large N as it is essentially proportional to N³. For example, when N=200, its complexity is larger than O(8×10⁶) whereas that of DEM1 is less than O(5×10³). As can be seen from FIG. 2 and Table I, the computational cost of the proposed method is much less than that of the existing method.

Relative motion between receivers and transmitters brings about the Doppler effect. If the array is moving along its baseline, the Doppler shift is given by ƒ_{D}=ƒ_{C}v sin θ/c where ƒ_{C} and θ are the center frequency and the arrival angle of an incoming signal, respectively, and v and c are the velocities of the array and the electromagnetic wave, respectively. The phase shift by the Doppler effect is φ_{D}(θ,t)=φ₀t sin θ where φ₀=2πƒ_{C}v/c. We have tacitly considered that the unit of time is a sampling period Tₛ. Otherwise φ₀=2πƒ_{C}Tₛv/c. The Doppler effect can be included in the array response vector instead of the complex envelope so that a(θ) is replaced by

$$a ( θ , t ) = {e}^{j {ϕ}_{D} ( θ , t )} a ( θ ) \qquad ( 36 )$$

The equations presented above can be applied in the presence of the Doppler effect via such replacement. For example, the nth diagonal entry of the block diagonal matrix C(θ) is a(θ, n), rather than a(θ).

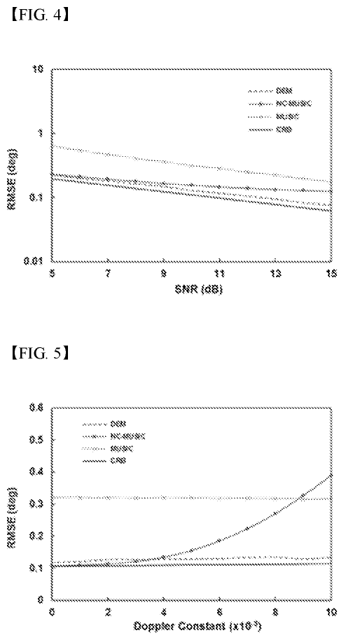

We investigate the estimation performance of the proposed method of the disclosure in comparison with those of other existing ones. To this end, a uniform linear array of five sensors with half a wavelength interelement spacing is employed, on which two BPSK signals are incident from θ₁=15° and θ₂=25° relative to broadside. They have the same signal-to-noise ratio (SNR). A total of 100 independent runs have been performed to find the average root mean square error (RMSE) for the arrival angles. When N=200 the performances of DEM1, MUSIC, and noncircular MUSIC (NC-MUSIC) are presented together with the CRB (Cramér-Rao bound). The MSE of θₖ is obtained as MSE(θₖ)=Σₗ₌₁^{L}(θ_{k,l}−θₖ)²/L where L=100 and θ_{k,l} is the estimate for θₗ at the lth trial. The average RMSE is defined as the square root of Σₖ₌₁^{K}MSE(θₖ)/K. Accordingly the corresponding CRB is obtained by taking the square root of the average of the bounds. As explained above, DEM1 has the same performance as DEM2. The direction estimates of MUSIC are used for the initial values of the DEM. The termination threshold is set at ε=0.01°. In FIGS. 3 and 4, φ₀=0.005.

In FIG. 3, where σ² is set at 0.001, gₖ⁽ⁱ⁾(θ) and hₖ⁽ⁱ⁾(θ), k=1, 2 at the 2nd iteration in one simulation run are illustrated. As the sensors are isotropic, ∥a(θ)∥²=5 regardless of θ. These results show that hₖ⁽²⁾(θ) is identical to 5gₖ⁽²⁾(θ), which confirms (35) and ensures that DEM1 and DEM2 have the same performance.

In FIG. 4, the RMSE performances are displayed as functions of SNR. One can see from (37) that when all signals have the same power, the CRB is inversely proportional to SNR, which is shown in FIG. 4. DEM and NC-MUSIC that exploit the noncircularity of received signals outperform MUSIC. However, NC-MUSIC suffers from the Doppler effect so that its performance improvement due to an increase in SNR is limited. In contrast, the RMSE of DEM, which is close to the CRB, decreases with an increase in SNR without such limitation.

When SNR is 10 dB FIG. 5 exhibits the RMSEs against the Doppler constant φ₀, which varies from 0 to 10⁻². Although the RMSE of NC-MUSIC when φ₀ is near zero is very close to the CRB, its performance is severely degraded as φ₀ increases. However, the performance of DEM, which takes the Doppler effect into consideration, is not deteriorated even though it is increased. The signal subspace corresponds to the column space of A(θ) regardless of whether or not φ₀ is zero, and the performance of MUSIC is also not degraded.

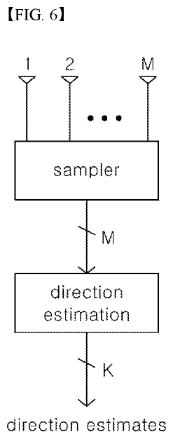

FIG. 6 is a block diagram of direction estimator according to an embodiment of the disclosure. The process of FIG. 1 described above may be performed in the direction estimator, and the direction estimator may be implemented in software and/or hardware and may be included in one device or in separate devices.

What is claimed is:

1. A method, when K noncircular signals are incident on a linear array from θ={θ₁, . . . , θ_{K}} where θₖ is the arrival angle of the kth signal, comprising:
sampling the received signals to obtain snapshot data x(n), n=1 . . . , N;
obtaining a decoupled vector for one signal which is found through signal separation from the snapshot data;
finding a function of two variables for the separated signal by using the decoupled vector, where the two variables are θ and ϕ related to its arrival angle and initial phase, respectively;
obtaining a cost function of θ from the two-variable function by theoretically solving the optimum value of ϕ; and
estimating the angle of arrival of the separated signal through the optimization of the cost function of θ.

2. The method of claim 1, after obtaining all K direction estimates, comprising:
iterating the process of optimization with new decoupled vectors that are found using the previous estimates; and
terminating the iteration if the condition that |θₖ⁽ⁱ⁾−θₖ⁽ⁱ⁻¹)|≤ε, k=1, . . . , K, is satisfied where θₖ^{(j)} is the estimate of θₖ at the jth iteration and ε is a small constant.

3. The method of claim 2, wherein
the received signal vector at time t corresponds to the following equation,
$$\begin{matrix}x ( t ) = A ( θ ) s ( t ) + n ( t ) \\ = A ( θ ) B ( ϕ ) γ ( t ) + n ( t )\end{matrix}$$
where time unit is the sampling time, s(t) is the complex envelope vector, n(t) is the noise vector, B(ϕ) is a diagonal matrix with the diagonal elements of the initial phases of the noncircular signals, i.e., B(ϕ)=diag [e^{jϕ}^{₁}, . . . , e^{jϕ}^{_{K}}], γ(t)=[γ₁(t), . . . , γ_{K}(t)]^{T} is a real vector, T stands for the transpose, A(θ)=[a(θ₁), . . . , a(θ_{K})], and a(θ) is the steering vector for a direction θ.

4. The method of claim 3, at the kth step in the ith iteration to estimate θₖ, wherein
the decoupled vector is calculated as
$${z}_{k}^{( i )} ( n ) = x ( n ) - A ( {θ}_{k}^{( i )} ) B ( {ϕ}_{k}^{( i )} ) {γ}_{k}^{( i )} ( n ) , n = 1 , … , N$$
where
$${γ}_{k}^{( i )} ( n ) = {[ {γ}_{1}^{( i )} ( n ) , … , {γ}_{k - 1}^{( i )} ( n ) , {γ}_{k + 1}^{( i - 1 )} ( n ) , … , {γ}_{K}^{( i - 1 )} ( n ) ]}^{T}$$
$${θ}_{k}^{( i )} = \{ {θ}_{1}^{( i )} , … , {θ}_{k - 1}^{( i )} , {θ}_{k + 1}^{( i - 1 )} , … , {θ}_{K}^{( i - 1 )} \}$$
$${ϕ}_{k}^{( i )} = \{ {ϕ}_{1}^{( i )} , … , {ϕ}_{k - 1}^{( i )} , {ϕ}_{k + 1}^{( i - 1 )} , … , {ϕ}_{K}^{( i - 1 )} \} .$$

5. The method of claim 4, comprising:
finding the two-variable function as
$${g}_{k}^{( i )} ( θ , ϕ ) = \frac{{d}_{1} ( θ ) {e}^{j 2 ϕ ( θ )} + {d}_{1}^{*} ( θ ) {e}^{- j 2 ϕ ( θ )} + 2 {d}_{0} ( θ )}{4 {‖ a ( θ ) ‖}^{2}}$$
where * designates the complex conjugate, ∥⋅∥ represents the Euclidean norm, and
$${d}_{0} ( θ ) = {\sum }_{n = 1}^{N} {\vert {a}^{T} ( θ ) {z}_{k}^{{( i )}^{*}} ( n ) \vert}^{2} \\ {d}_{1} ( θ ) = {\sum }_{n = 1}^{N} {( {a}^{T} ( θ ) {z}_{k}^{{( i )}^{*}} ( n ) )}^{2} .$$

6. The method of claim 5, at each θ, comprising:
obtaining the optimum value of ϕ(θ) as
$$ϕ ( θ ) = - ψ ( θ ) / 2$$
and the maximum of gₖ⁽ⁱ⁾(θ, ϕ) as
$${g}_{k}^{( i )} ( θ ) = \frac{\vert {d}_{1} ( θ ) \vert + {d}_{0} ( θ )}{2 {‖ a ( θ ) ‖}^{2}}$$
where d₁(θ)=|d₁(θ)|e^{jψ(θ)}.

7. The method of claim 6, comprising:
obtaining the estimates of θₖ and ϕₖ as
$${θ}_{k}^{( i )} = arg {max}_{θ} {g}_{k}^{( i )} ( θ ) \\ {ϕ}_{k}^{( i )} = - ψ ( {θ}_{k}^{( i )} ) / 2.$$

8. The method of claim 7, comprising:
calculating γₖ⁽ⁱ⁾(n) as
$${γ}_{k}^{( i )} ( n ) = Re ( {e}^{- j {ϕ}_{k}^{( i )}} {a}^{H} ( {θ}_{k}^{( i )} ) {z}_{k}^{( i )} ( n ) ) / {‖ a ( {θ}_{k}^{( i )} ) ‖}^{2} , n = 1 , … , N$$
where Re and H designate the real part of a complex number and the complex conjugate transpose, respectively.

9. The method of claim 2, wherein
in the presence of Doppler effect by motion of the linear array, a(θ) and A(θ) are replaced by a(θ, t)=e^{jφ}^{_{D}}^{(θ,t)}a(θ) and A(θ, t)=[a(θ₁, t), . . . , a(θ_{K}, t)], where, when the center frequency is ƒ_{C} and the velocity of the linear array is v in its baseline direction, φ_{D}(θ,t)=φ₀t sin θ with φ₀=2πƒ_{C}v/c and c denoting the speed of light.

10. The method of claim 9, wherein
the received signal vector at time t corresponds to the following equation,
$$\begin{matrix}x ( t ) = A ( θ , t ) s ( t ) + n ( t ) \\ = A ( θ , t ) B ( ϕ ) γ ( t ) + n ( t ) .\end{matrix}$$

11. The method of claim 10, wherein
the decoupled vector is calculated as
$${z}_{k}^{( i )} ( n ) = x ( n ) - A ( {θ}_{k}^{( i )} , n ) B ( {ϕ}_{k}^{( i )} ) {γ}_{k}^{( i )} ( n ) , n = 1 , … , N .$$

12. The method of claim 11, comprising:
finding the two-variable function, using the equality of ∥a(θ, n)∥=∥a(θ)∥, as
$${g}_{k}^{( i )} ( θ , ϕ ) = \frac{{d}_{1} ( θ ) {e}^{j 2 ϕ ( θ )} + {d}_{1}^{*} ( θ ) {e}^{- j 2 ϕ ( θ )} + 2 {d}_{0} ( θ )}{4 {‖ a ( θ ) ‖}^{2}}$$
where
$${d}_{0} ( θ ) = {\sum }_{n = 1}^{N} {\vert {a}^{T} ( θ , n ) {z}_{k}^{{( i )}^{*}} ( n ) \vert}^{2} \\ {d}_{1} ( θ ) = {\sum }_{n = 1}^{N} {( {a}^{T} ( θ , n ) {z}_{k}^{{( i )}^{*}} ( n ) )}^{2} .$$

13. The method of claim 12, at each θ, comprising:
obtaining the optimum value of ϕ(θ) as
$$ϕ ( θ ) = - ψ ( θ ) / 2$$
and the maximum of gₖ⁽ⁱ⁾(θ, ϕ) as
$${g}_{k}^{( i )} ( θ ) = \frac{\vert {d}_{1} ( θ ) \vert + {d}_{0} ( θ )}{2 {‖ a ( θ ) ‖}^{2}}$$
where d₁(θ)=|d₁(θ)|e^{jψ(θ)}.

14. The method of claim 13, comprising:
obtaining the estimates of θₖ and ϕₖ as
$${θ}_{k}^{( i )} = arg {max}_{θ} {g}_{k}^{( i )} ( θ ) \\ {ϕ}_{k}^{( i )} = - ψ ( {θ}_{k}^{( i )} ) / 2.$$

15. The method of claim 14, comprising:
calculating the γₖ⁽ⁱ⁾(n) as
$${γ}_{k}^{( i )} ( n ) = Re ( {e}^{- j {ϕ}_{k}^{( i )}} {a}^{H} ( {θ}_{k}^{( i )} , n ) {z}_{k}^{( i )} ( n ) ) / {‖ a ( {θ}_{k}^{( i )} ) ‖}^{2} , n = 1 , … , N .$$
